(19) United States
(12) Patent Application Publication
(10) Pub. No.: US 2017/0303190 A1
(43) Pub. Date: Oct. 19, 2017

(54) METHOD AND DEVICE FOR COMMUNICATING BETWEEN A PARKING FACILITY MANAGEMENT SYSTEM AND A MOTOR VEHICLE

(71) Applicant: Robert Bosch GmbH, Stuttgart (DE)

(72) Inventors: Florian Koch, Hannover (DE); Felix Hess, Ludwigsburg (DE); Muhammad Irfan Rafique, Hildesheim (DE)

(21) Appl. No.: 15/471,149

(22) Filed: Mar. 28, 2017

(30) Foreign Application Priority Data
Apr. 13, 2016 (DE) 102016206149.6

(51) Int. Cl. H04W 48/20; H04L 29/08; H04W 36/32; H04W 36/08; H04W 88/08; H04W 84/12

(52) U.S. Cl. CPC H04W 48/20; H04W 36/32; H04W 36/08; H04L 67/12; H04W 84/12; H04W 88/08

(57) ABSTRACT

A method for communicating between a parking facility management system of a parking facility and a motor vehicle driving in a driverless fashion within the parking facility, the parking facility including multiple spatially distributed base stations, based on a present position of the motor vehicle within the parking facility and on a digital map of the parking facility, which includes the positions of the multiple base stations, a base station being selected from the multiple base stations to which the motor vehicle is to change next from a present base station of the multiple base stations to which the motor vehicle is presently connected, to connect itself to the selected base station in order to communicate with the parking facility management system. A corresponding device, a motor vehicle, a parking facility management system, and a computer program are also described.

### CROSS REFERENCE

The present application claims the benefit under 35 U.S.C. §119 of German Patent Application No. DE 102016206149.6 filed on Apr. 13, 2016, which is expressly incorporated herein by reference in its entirety.

### FIELD

The present invention relates to a method for communicating between a parking facility management system of a parking facility and a motor vehicle driving in a driverless fashion within the parking facility. The present invention furthermore relates to a device for communicating between a parking facility management system of a parking facility and a motor vehicle driving in a driverless fashion within the parking facility. The present invention furthermore relates to a motor vehicle, a parking facility management system, and a computer program.

### BACKGROUND INFORMATION

German Patent Application No. DE 10 2013 222 071 A1 describes a parking facility management system. The parking facility management system transmits, for example, position data of a parking space assigned to the vehicle via a communication network to the vehicle.

German Patent Application No. DE 10 2012 222 562 A1 describes a system for managed parking areas for transferring a vehicle from a start position to a destination position.

### SUMMARY

An object of the present invention may be to provide for efficient communication between a parking facility management system of a parking facility and a motor vehicle driving in a driverless fashion within the parking facility.

This object may be achieved with the aid of the present invention. Advantageous embodiments of the present invention are described herein.

According to one aspect, a method is provided for communicating between a parking facility management system of a parking facility and a motor vehicle driving in a driverless fashion within the parking facility, the parking facility including multiple spatially distributed base stations, based on a present position of the motor vehicle within the parking facility and on a digital map of the parking facility, which includes the positions of the multiple base stations, one base station being selected from the multiple base stations, to which the motor vehicle is to change next from a present base station of the multiple base stations to which the motor vehicle is presently connected, to connect itself to the selected base station in order to communicate with the parking facility management system.

According to another aspect, a device is provided for communicating between a parking facility management system of a parking facility and a motor vehicle driving in a driverless fashion within the parking facility, the parking facility including multiple spatially distributed base stations, including:
a memory, in which a digital map of the parking facility is stored, the digital map including the positions of the multiple base stations,
a processor, which is designed, based on a present position of the motor vehicle within the parking facility and on the digital map of the parking facility, to select one base station from the multiple base stations, to which the motor vehicle is to change next from a present base station of the multiple base stations to which the motor vehicle is presently connected, to connect itself to the selected base station in order to communicate with the parking facility management system.

According to another aspect, a motor vehicle is provided, which includes the device according to the present invention.

According to another aspect, a parking facility management system is provided, which includes the device according to the present invention.

According to still another aspect, a computer program is provided, which includes program code for carrying out the method according to the present invention when the computer program is executed on a computer.

According to one aspect, a parking facility for motor vehicles is provided, which includes the parking facility management system.

The present invention is based on the finding that the above object may be achieved in that the base station, to which the motor vehicle is to change for the purpose of connection, in order to communicate via this base station with the parking facility management system, is selected both based on a present position of the motor vehicle within the parking facility and on a digital map of the parking facility, which includes the positions of the multiple base stations. This means in particular that time-consuming scanning for available base stations may thus be omitted. It is therefore advantageously specified to the motor vehicle in particular to which base station the motor vehicle is to change next.

The present invention is thus based in particular on the use of the knowledge where the base stations are located within the parking facility, and on the use of the knowledge of the present position of the motor vehicle within the parking facility, to select the base station from the multiple base stations to which the motor vehicle is to connect next.

This therefore yields the technical advantage in particular that a concept for efficient communication between a parking facility management system of a parking facility and a motor vehicle driving in a driverless fashion within the parking facility is provided.

A connection within the meaning of the present invention is in particular a communication link. This means in particular that a communication link is thus established between the parking facility management system and the motor vehicle. The base stations of the parking facility are used to establish this communication link. The motor vehicle will have to use multiple of these base stations as it drives in the parking facility, since one base station generally cannot cover the entire parking facility.

Therefore, multiple base stations are available in a communication network which extends over the parking facility. A client, the motor vehicle here, typically scans all receivable base stations during the first establishment of a link with the communication network and typically connects itself to the base station which has the best reception.

When the motor vehicle moves within the parking facility, it will arrive from a certain point in an area in which the motor vehicle may receive poorly the base station to which it has originally connected. This may have the result that a communication link to the parking facility management system is interrupted or breaks off. At the latest when reception breaks off completely, the client, the motor vehicle here, typically begins to scan for better receivable base stations and connects itself when it has found one.

However, in this approach, poor reception conditions may occur over a certain time, in particular before a change of the base station, and as long as the motor vehicle is scanning for new stations, generally reception is not possible at all. Such an approach may therefore result in a high latency and a reduced data rate, which are not sufficient for an AVP application, for example.

This is because in the AVP application, AVP standing for “automated valet parking”, which may be called an “automatic parking process”, a stable communication link is generally required between the motor vehicle and the parking facility management system, having a preferably low latency. Such a communication link is used, for example, so that the parking facility management system may transmit position data to the motor vehicle of a parking space assigned to the motor vehicle. Such a communication link is used, for example, so that the parking facility management system may transmit remote control commands to the motor vehicle, to guide the motor vehicle by remote control within the parking facility. Such a communication link is used, for example, so that the parking facility management system may transmit a digital map of the parking facility to the motor vehicle, so that the motor vehicle may subsequently drive in a driverless fashion autonomously within the parking facility based on the digital map.

Since it is provided according to the present invention to select a next base station for the motor vehicle, the motor vehicle itself therefore no longer has to scan for receivable base stations in a time-consuming fashion.

A parking facility within the meaning of the present invention may also be referred to as a parking area and is used as a parking lot for motor vehicles. The parking facility therefore forms in particular a contiguous area, which includes multiple parking spaces (in the case of a parking facility on private property) or parking zones (in the case of a parking facility on public property). According to one specific embodiment, the parking facility is designed as a parking deck. According to one specific embodiment, the parking facility is designed as a parking garage.

According to one specific embodiment, the communication network includes a WLAN network and/or a mobile network.

A base station within the meaning of the present invention is therefore designed, for example, as a WLAN base station.

A base station within the meaning of the present invention is designed, for example, as a mobile radio base station.

A base station within the meaning of the present invention is designed, for example, as a WLAN access point.

According to one specific embodiment it is provided that a change instruction that the motor vehicle is to change from the present base station to the selected base station is transmitted via a communication network to the motor vehicle.

This yields the technical advantage in particular that the point in time at which the motor vehicle is to change the base station may be specified efficiently. The change instruction is thus specified to the motor vehicle that it is to change the base station. The change point in time essentially corresponds here to the point in time of the reception of the change instruction on the part of the motor vehicle plus a latency, which may be in the range from several milliseconds to several hundred milliseconds in WLAN communication networks, for example.

According to one specific embodiment, it is provided that the change instruction includes a point in time at which the motor vehicle is to change the base station. This yields the technical advantage, for example, that the point in time at which the motor vehicle is to change the base station may be efficiently specified to the motor vehicle. This point in time is thus in the future, and may thus also be referred to as a future point in time. As soon as this point in time is reached, the motor vehicle changes the base station.

For example, the change instruction includes a location within the parking facility at which the motor vehicle is to change the base station. This yields the technical advantage, for example, that the location at which the motor vehicle is to change the base station may be specified efficiently to the motor vehicle.

According to one specific embodiment it is provided that the motor vehicle changes the base station in response to receiving the change instruction.

If the change instruction includes the point in time at which the motor vehicle is to change the base station, it is provided according to one specific embodiment that the motor vehicle changes the base station at the specified point in time in response to a reception of such a change instruction.

If the change instruction includes a location at which the vehicle is to change the base station it is provided according to one specific embodiment, that the motor vehicle changes the base station in response to a reception of such a change instruction when the motor vehicle is located at the specified location.

A change of the base station within the meaning of the present invention refers to a change of the motor vehicle from the present base station to the selected base station.

According to one specific embodiment it is provided that the selection is carried out as a function of a destination position located within the parking facility, to which the motor vehicle is to drive.

This yields the technical advantage in particular that the selection may be carried out efficiently. This is because base stations which are outside a radio range of the destination position no longer have to be taken into consideration in the selection depending on where the motor vehicle is to drive to.

The destination position is, for example, an end position of a leg of a setpoint trajectory to be followed by the motor vehicle. This means in particular that the setpoint trajectory is divided into multiple legs, which each have an end position. The motor vehicle thus travels from one end position of one leg to another end position of another leg, until it has completed following the setpoint trajectory.

The destination position is, for example, an end position of the setpoint trajectory.

A setpoint trajectory ends, for example, at a parking position (parking space or parking zone) of the parking facility at which the motor vehicle is to park. A setpoint trajectory ends, for example, at a pick-up position of the parking facility, at which a user is to pick up the motor vehicle.

According to another specific embodiment, it is provided that the selection is carried out depending on a setpoint trajectory which the motor vehicle is to follow.

This yields the technical advantage in particular that the selection may be carried out efficiently. This is in particular because base stations, which are located outside a radio range of the setpoint trajectory, no longer have to be taken into consideration during the selection. The setpoint trajectory to be followed in particular means the setpoint trajectory still to be followed by the motor vehicle here, i.e., the setpoint trajectory which is still ahead of the motor vehicle with respect to a travel direction of the motor vehicle.

According to one specific embodiment it is provided that the selection is carried out depending on a present motor vehicle velocity.

This yields the technical advantage in particular that the selection may be carried out efficiently. This is because a base station may thus be specified to the motor vehicle, for example, which is farther away from the motor vehicle in relation to the present position of the motor vehicle than another base station. This is because the motor vehicle will be able to drive with appropriate speed to the base station as a result of its motor vehicle velocity. If the base station located closer were specified to the motor vehicle in this exemplary application, a change to the more remote base station would nonetheless have to take place as a result of the motor vehicle velocity, which would result in an additional change of the base station. Since a change of the base station generally includes logging out from the present base station and logging into the selected base station, time may be saved efficiently by leaving out one base station, as one logging-in process may be omitted.

According to one specific embodiment, it is provided that the digital map includes areas around the base stations which have different reception conditions with respect to a latency and/or a data rate, the selection being carried out as a function of the different reception conditions. This yields the technical advantage in particular that the selection may be carried out efficiently. This is because it is now advantageously made possible for a minimum data rate and/or a maximum latency to be provided due to the selection of a suitable base station.

The selection is thus carried out, for example, in such a way that the data rate does not fall below a specified minimum data rate. For example, it is provided that the selection is carried out in such a way that a maximum specified latency is not exceeded.

According to another specific embodiment, it is provided that the selection is carried out as a function of one condition that the motor vehicle always has to have a direct line-of-sight to one base station of the multiple base stations.

This yields the technical advantage in particular that a robust communication link to the parking facility management system may be established or maintained, respectively. This is because a direct line-of-sight between the motor vehicle and the base station typically guarantees or ensures an interruption-free communication link. This is because there are no objects which shield the wireless signals, for example, a column or a wall, in a direct line-of-sight.

According to one specific embodiment, it is provided that the device for communicating between a parking facility management system of a parking facility and a motor vehicle driving in a driverless fashion within the parking facility is configured or designed to execute or carry out the method for communicating between a parking facility management system of a parking facility and a motor vehicle driving in a driverless fashion within the parking facility.

According to one specific embodiment, it is provided that the motor vehicle is designed or configured to execute or carry out the method according to the present invention.

According to one specific embodiment, it is provided that the parking facility management system is designed or configured to execute or carry out the method according to the present invention.

According to another specific embodiment, a communication interface is provided, which is designed to communicate via a communication network.

According to one specific embodiment, it is provided that the multiple spatially distributed base stations establish a wireless communication network.

According to one specific embodiment, it is provided that a wireless communication network is formed with the aid of the multiple spatially distributed base stations.

According to one specific embodiment, it is provided that the device includes the above-mentioned communication interface.

According to one specific embodiment, it is provided that the motor vehicle includes the above-mentioned communication interface.

According to one specific embodiment, it is provided that the parking facility management system includes the above-mentioned communication interface.

Technical functionalities of the method result similarly from corresponding technical functionalities of the device and vice versa. This means in particular that method features thus result from corresponding device features and vice versa.

According to one specific embodiment, it is provided that the communication interface is designed to transmit a change instruction, that the vehicle is to change from the present base station to the selected base station, via a communication network to the motor vehicle.

According to one specific embodiment, it is provided that the processor is designed to carry out the selection as a function of a destination position located within the parking facility, to which the motor vehicle is to drive.

According to one specific embodiment, it is provided that the processor is designed to carry out the selection as a function of a setpoint trajectory to be followed by the motor vehicle.

According to one specific embodiment, it is provided that the processor is designed to carry out the selection as a function of a present motor vehicle velocity.

According to one specific embodiment, it is provided that the digital map includes areas around the base stations which have different reception conditions with respect to a latency and/or a data rate.

According to one specific embodiment, it is provided that the processor is designed to carry out the selection as a function of the different reception conditions.

According to one specific embodiment, it is provided that the processor is designed to carry out the selection as a function of one condition that the motor vehicle always has to have a direct line-of-sight to one base station of the multiple base stations.

According to one specific embodiment, it is provided that one step of the method or multiple steps of the method or all steps of the method are carried out in the motor vehicle.

According to one specific embodiment, it is provided that one step of the method or multiple steps of the method or all steps of the method are carried out in the parking facility management system.

According to one specific embodiment, it is provided that the present position of the motor vehicle within the parking facility is ascertained.

The ascertainment of the present position of the motor vehicle includes, for example, the motor vehicle ascertaining its present position itself. The motor vehicle transmits, for example, its position ascertained itself via a communication network to the parking facility management system or to the device, respectively.

The ascertainment of the present position of the motor vehicle includes, for example, the motor vehicle being monitored with the aid of a monitoring system of the parking facility during its driverless travel within the parking facility.

Such a monitoring system includes, according to one specific embodiment, one or multiple surroundings sensors. A surroundings sensor is, for example, one of the following surroundings sensors: video sensor, radar sensor, ultrasonic sensor, LIDAR sensor, laser sensor, infrared sensor, and magnetic sensor. For example, the monitoring system includes one or multiple video cameras. For example, the monitoring system includes one or multiple light barriers and/or one or multiple door opening sensors.

It is therefore made possible to track a driverless travel of the motor vehicle within the parking facility with the aid of the monitoring system. Knowledge about the present position of the motor vehicle is therefore always available with the aid of the monitoring system. According to one specific embodiment, the driverless travel of the motor vehicle is tracked or monitored, respectively, with the aid of the monitoring system, the present position of the motor vehicle within the parking facility being determined or ascertained based on the monitoring or tracking, respectively.

The wording “respectively” in particular includes the wording “and/or”.

The present invention is explained in greater detail herein on the basis of preferred exemplary embodiments.

### BRIEF DESCRIPTION OF THE DRAWINGS

FIG. 1 shows a flow chart of a method for communicating between a parking facility management system of a parking facility and a motor vehicle driving in a driverless fashion within the parking facility.

FIG. 2 shows a flow chart of a further method for communicating between a parking facility management system of a parking facility and a motor vehicle driving in a driverless fashion within the parking facility.

FIG. 3 shows a device for communicating between a parking facility management system of a parking facility and a motor vehicle driving in a driverless fashion within the parking facility.

FIG. 4 shows a motor vehicle.

FIG. 5 shows a parking facility management system.

FIG. 6 shows two base stations of a parking facility.

FIG. 7 shows two further base stations of the parking facility of FIG. 6.

### DETAILED DESCRIPTION OF EXAMPLE EMBODIMENTS

Identical reference numerals may be used for identical features hereafter.

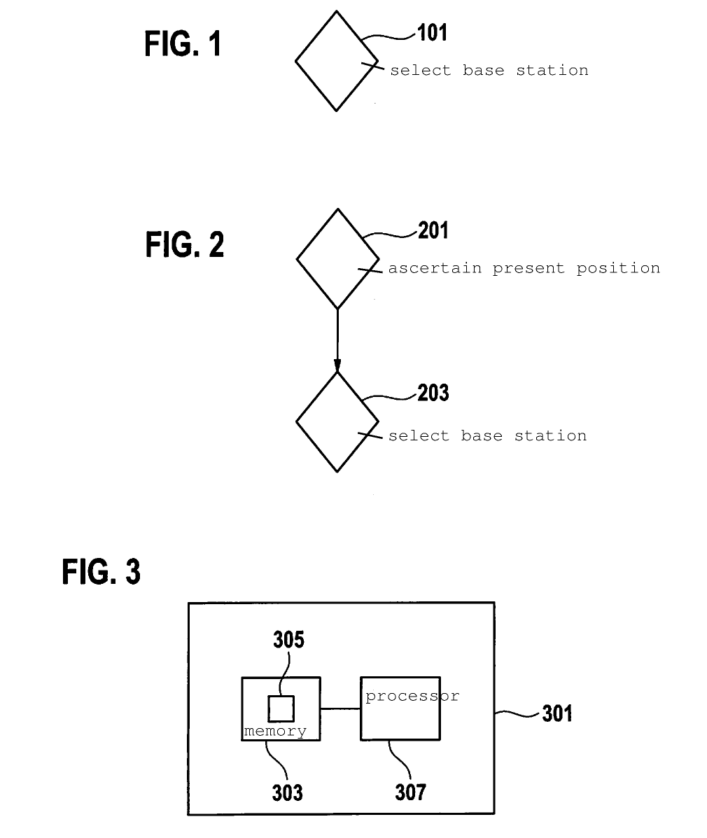

FIG. 1 shows a flow chart of a method for communicating between a parking facility management system of a parking facility and a motor vehicle driving in a driverless fashion within the parking facility.

The parking facility includes multiple spatially distributed base stations. A wireless communication network is formed or established with the aid of the multiple base stations. It is possible to communicate with the parking facility management system via the wireless communication network. This means in particular that the vehicle thus may communicate or communicates, respectively, with the parking facility management system during its driverless travel within the parking facility via the wireless communication network.

According to a step 101 it is provided that, based on a present position of the motor vehicle within the parking facility and on a digital map of the parking facility, which includes the positions of the multiple base stations, one base station is selected from the multiple base stations to which the motor vehicle is to change next from a present base station of the multiple base stations to which the motor vehicle is presently connected, to connect itself to the selected base station, in order to communicate with the parking facility management system.

According to one specific embodiment it is provided that the motor vehicle changes from the present base station to the selected base station to connect itself to the selected base station. According to one specific embodiment, it is provided that the motor vehicle connects itself to the selected base station after the change.

According to one specific embodiment, it is provided that the selection is carried out in the motor vehicle. According to one specific embodiment, it is provided that the selection is carried out in the parking facility management system.

According to one specific embodiment, it is provided that the parking facility management system transmits a change instruction that the vehicle is to change from the present base station to the selected base station via the wireless communication network to the motor vehicle.

FIG. 2 shows a flow chart of a further method for communicating between a parking facility management system of a parking facility and a motor vehicle driving in a driverless fashion within the parking facility, the parking facility including multiple spatially distributed base stations.

The multiple spatially distributed base stations are designed to establish a wireless communication network. This means that a wireless communication network thus extends within the parking facility, which is established or formed with the aid of the multiple base stations.

In a step 201, it is provided that a present position of the motor vehicle within the parking facility is ascertained. For example, it is provided that the motor vehicle ascertains its present position itself and transmits it via the wireless communication network to the parking facility management system. For example, the present position of the motor vehicle is ascertained based on a monitoring system, as described above.

In a step 203, it is provided that, based on the present position of the motor vehicle within the parking facility and on a digital map of the parking facility, which includes the positions of the multiple base stations, one base station is selected from the multiple base stations to which the motor vehicle is to change next from a present base station of the multiple base stations to which the motor vehicle is presently connected, to connect itself to the selected base station, in order to communicate with the parking facility management system.

In one specific embodiment, it is provided that the digital map of the parking facility, which includes the positions of the multiple base stations, is transmitted from the parking facility management system to the motor vehicle via the wireless communication network. The digital map is therefore advantageously available in the motor vehicle for carrying out the method.

FIG. 3 shows a device 301 for communicating between a parking facility management system of a parking facility and a motor vehicle driving in a driverless fashion within the parking facility, the parking facility including multiple spatially distributed base stations.

Device 301 includes:
a memory 303, in which a digital map 305 of the parking facility is stored, the digital map including the positions of the multiple base stations,
a processor 307, which is designed, based on a present position of the motor vehicle within the parking facility and on the digital map of the parking facility, to select one base station from the multiple base stations to which the motor vehicle is to change next from a present base station of the multiple base stations, to which the motor vehicle is presently connected, to connect itself to the selected base station in order to communicate with the parking facility management system.

According to one specific embodiment, device 301 includes a communication interface, which is designed to communicate via the wireless communication network.

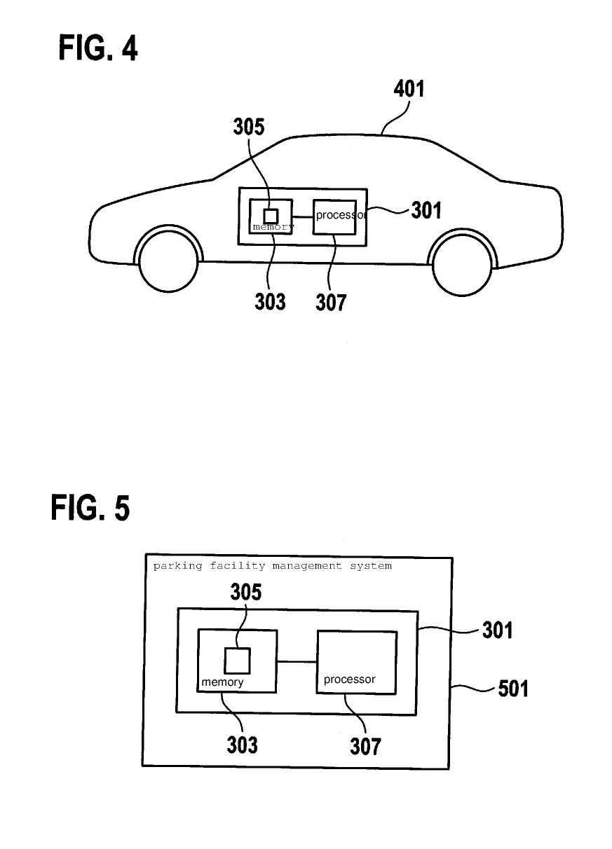

FIG. 4 shows a motor vehicle 401.

Motor vehicle 401 includes device 301 of FIG. 3.

According to one specific embodiment it is provided that the motor vehicle includes a communication interface, which is designed to communicate via a wireless communication network, in particular to communicate with a parking facility management system of a parking facility.

Motor vehicle 401 is designed according to one specific embodiment to drive in a driverless fashion autonomously within the parking facility.

According to one specific embodiment it is provided that motor vehicle 401 is designed to drive in a driverless fashion by remote control within the parking facility. This means in particular that motor vehicle 401 is thus remote-controlled, for example. For example, it is provided that the parking facility management system remotely controls the motor vehicle.

This means in particular that motor vehicle 401 is thus designed to drive in a driverless fashion within the parking facility.

This means in particular that driverless driving within the meaning of the present invention may thus include, for example, remote controlled driving and/or autonomous driving.

FIG. 5 shows a parking facility management system 501.

Parking facility management system 501 includes device 301 of FIG. 3.

According to one specific embodiment, parking facility management system 501 includes a communication interface, which is designed to communicate via a wireless communication network, in particular to communicate with a motor vehicle which drives in a driverless fashion within the parking facility.

According to one specific embodiment it is provided that parking facility management system 501 is designed to remotely control a motor vehicle within the parking facility.

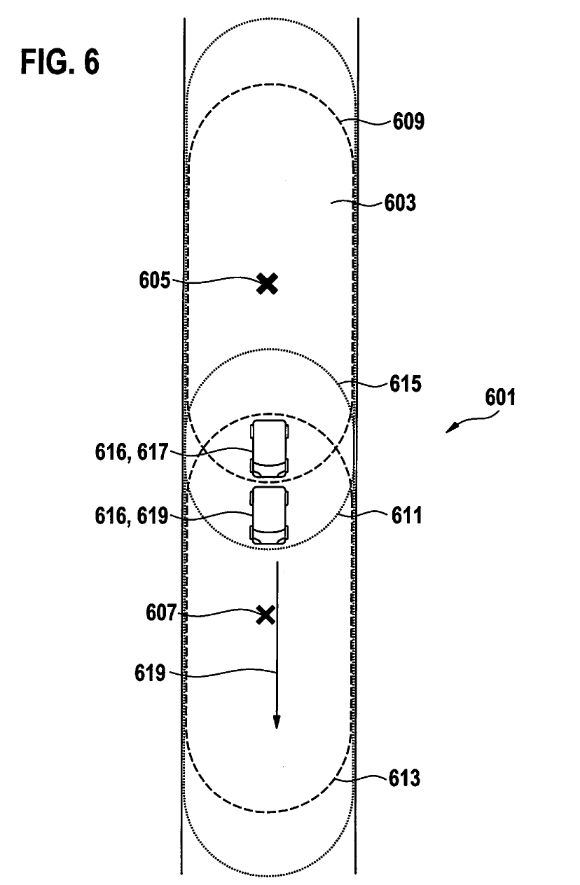

FIG. 6 shows a detail of a parking facility 601 for motor vehicles in a simplified form.

Parking facility 601 includes a vehicle passageway 603. Parking facility 601 furthermore includes a first base station 605 and a second base station 607. The two base stations 605, 607 are situated spatially distributed within parking facility 601. For example, it is provided that the two base station 605, 607 are situated on a ceiling above vehicle passageway 603.

The two base stations 605, 607 are shown as a cross on vehicle passageway 603 in the drawing, but it is clear to those skilled in the art that this only has symbolic meaning. The two base stations 605, 607 may be situated on a ceiling, for example, as explained above or on infrastructure elements of parking facility 601, for example. Infrastructure elements include, for example, columns or walls.

A first area 609 is defined around first base station 605, which is symbolically shown as an oval delineated by a dashed line.

A communication link to first base station 605, which has, for example, a predetermined minimum data rate or a predetermined maximum latency, is enabled within first area 609.

The farther a client, a motor vehicle here, moves away from first base station 605, generally the worse reception becomes. Therefore, a second area 611, which is shown with the aid of two curves delineated with a dotted line and adjoins first area 609, is defined around first base station 605.

As a result of the greater distance, a data rate is reduced or a latency is increased, respectively, within second area 611 in comparison to first area 609.

Similarly to first base station 605, a first area 613, which corresponds to first area 609 of first base station 605, is also defined around second base station 607.

A second area 615, which corresponds to second area 611 of first base station 605, is similarly defined around second base station 607.

The two areas 613, 615 of second base station 607 are shown in the drawings similarly to corresponding areas 609, 611 of first base station 605. Reference is made to the correspondingly made statements to avoid repetitions.

A motor vehicle 616 drives on vehicle passageway 603. A travel direction of motor vehicle 616 is shown symbolically by an arrow having reference numeral 619.

This means that motor vehicle 616 thus drives from first base station 605 in the direction of second base station 607.

FIG. 6 shows motor vehicle 616 at two successive points in time. In this case, reference numeral 617 points to motor vehicle 616 when it drives in a driverless fashion at a first point in time on vehicle passageway 603 in travel direction 619.

Reference numeral 619 points to vehicle 616 at a second point in time, which is chronologically after the first point in time, when motor vehicle 616 travels in a driverless fashion on vehicle passageway 603 in travel direction 619.

During its travel on vehicle passageway 603 in travel direction 619, the motor vehicle will drive within first area 609 of first base station 605. Reception is correspondingly good. Motor vehicle 616 will thus connect itself to first base station 605 and communicate via this connection with a parking facility management system (not shown here).

While motor vehicle 616 moves in travel direction 619, it will leave first area 609 and drive into second area 611, this corresponding to the second point in time by way of example.

The reception will worsen, i.e., a communication link to first base station 605 will become worse. Motor vehicle 616 would typically only then scan for a further base station, which is better receivable.

It is now provided that two base stations 605, 607 are situated in such a way that their particular first areas 609, 613 overlap. When motor vehicle 616 is thus located within this overlapping area, it may both communicate optimally with first base station 605 and also optimally with second base station 607. According to the present invention, it is provided that motor vehicle 616 changes from first base station 605 to second base station 607 precisely when motor vehicle 616 is located within the overlapping area. It is thus symbolically shown in FIG. 6 that motor vehicle 616 is located on vehicle passageway 603 at the first point in time, symbolically identified by reference numeral 617.

It is therefore always ensured that motor vehicle 616 may establish an optimum communication link to one of the base stations, which are spatially distributed within parking facility 601.

To now be able to ascertain when and/or where motor vehicle 616 is to change from first base station 605 to second base station 607, according to the present invention, a digital map of parking facility 601 is provided, the digital map including the positions of the multiple base stations, i.e., in particular the positions of first base station 605 and second base station 607. Furthermore, the digital map includes areas 609, 611, 613, 615 of the two base stations 605, 607, which, as explained above, have different reception conditions with respect to a latency and/or a data rate.

Furthermore, it is provided in particular that a present position of motor vehicle 616 within parking facility 601 is ascertained. Based on the knowledge of where the motor vehicle is located within parking facility 601, and based on the knowledge of where which base station is located within parking facility 601, and based on the knowledge of which reception conditions prevail in the surroundings of the base stations, a point in time may therefore advantageously be ascertained at which motor vehicle 616 is to change from first base station 605 to second base station 607. In particular, based on this knowledge, second base station 607 may be selected as the base station to which motor vehicle 616 is to change.

For example, it is provided that a change instruction, as explained above, is transmitted via the wireless communication network, i.e., here via first base station 605 to motor vehicle 616, so that the motor vehicle changes in response to a reception of the change instruction from first base station 605 to second base station 607, to connect itself thereto, in order to communicate with the parking facility management system via this communication link.

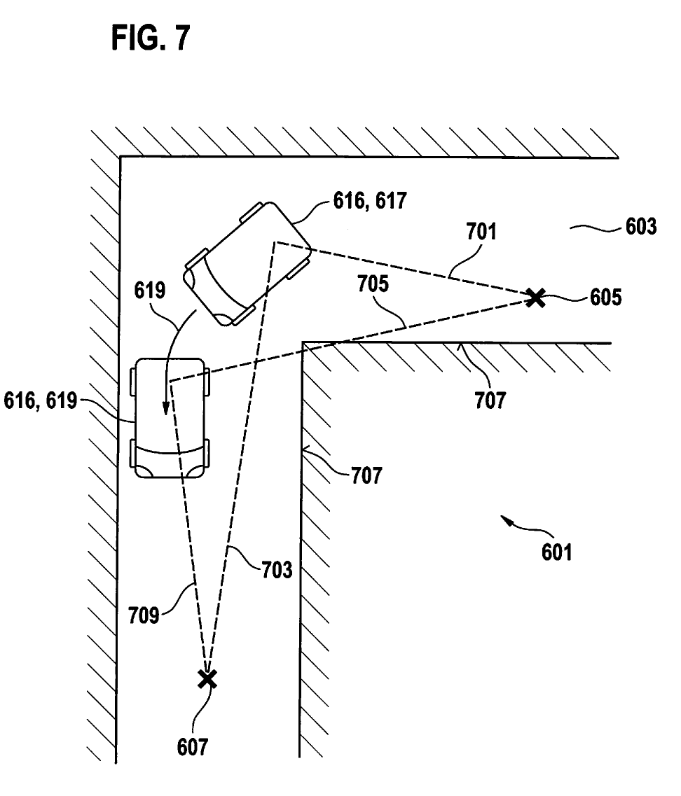

FIG. 7 shows a further area of parking facility 601.

Identical reference numerals are used here for identical features as in FIG. 6.

FIG. 7 shows an area in which motor vehicle 616 has to drive around a corner. The two base stations 605, 607 are situated in such a way that there is no direct line-of-sight between the two base stations 605, 607.

As soon as motor vehicle 616 drives around the corner, i.e., coming from first base station 605 in the direction of second base station 607 driving in travel direction 619, motor vehicle 616 is thus instructed with the aid of a change instruction to change from first base station 605 to second base station 607. Second base station 607 is even farther away from motor vehicle 616 in comparison to first base station 605, which could possibly result in worse reception. However, this process advantageously prevents a communication link between motor vehicle 616 and first base station 605 from breaking off completely. This could take place if motor vehicle 616 is located on vehicle passageway 603 at the second point in time, symbolically identified by reference numeral 616, i.e., when it has already turned around the corner. This is because concrete walls 707 are then located between motor vehicle 616 and first base station 605. There is therefore no longer a direct line-of-sight between motor vehicle 616 and first base station 605. This is symbolically shown with the aid of a dashed line 705, which is interrupted by the two concrete walls 707 due to the nonexistent line-of-sight.

However, since motor vehicle 616 is instructed to change the base station at the first point in time, symbolically identified by reference numeral 617, it may be ensured that there is always a line-of-sight between motor vehicle 616 and one of base stations 605, 607. This means that motor vehicle 616 is thus instructed in the corner area to change the base station. In the position according to the first point in time, symbolically identified by reference numeral 617, there is a line-of-sight 701 between motor vehicle 616 and first base station 605. Furthermore, there is a line-of-sight 703 between motor vehicle 616 and second base station 607 in this position.

There is also a direct line-of-sight between motor vehicle 616 and second base station 607 when motor vehicle 616 is in the position according to the second point in time, symbolically identified by reference numeral 619. This line-of-sight is also shown with the aid of a dashed line having reference numeral 709.

According to this specific embodiment, it is also provided that a change instruction is thus transmitted to the motor vehicle via the wireless communication network when it is located in the position corresponding to the first point in time, so that there is always a direct line-of-sight to base stations 605, 607.

Parking facility 601 has further base stations (not shown in FIGS. 6 and 7), which are situated spatially distributed within parking facility 601. Of these multiple base stations, as described above, second base station 607 has been designed as the base station to which motor vehicle 616 is to change from first base station 605, to connect itself thereto, in order to communicate with the parking facility management system.

The selection was carried out in particular as a function of the present position of motor vehicle 616 within parking facility 601. In particular, the selection was carried out as a function of travel direction 619 of motor vehicle 616.

In summary, an efficient concept is provided which includes the motor vehicle changing between the base stations as a function of its present position within the parking facility and the digital map, i.e., as a function of items of stored information on positions of the base stations, in such a way that the motor vehicle always remains in the area of good reception. Good reception is defined here in particular in such a way that a communication link between the motor vehicle and the base station has a specified minimum data rate and/or a specified maximum latency.

It is provided that the base station to which the motor vehicle is to change within the parking facility is selected in such a way that, for example, there is always a direct line-of-sight between the motor vehicle, i.e., in particular between a vehicle antenna, and the base station.

Line-of-sight within the meaning of the present invention is in particular a connection between a communication interface, in particular a vehicle antenna, of the motor vehicle and a base station.

Advantages according to the present invention are in particular that time-consuming scanning for available base stations may be omitted. This means that scanning for available base stations is dispensed with.

In particular, an advantage according to the present invention is that a change to another base station may already take place before a connection quality with respect to latency and data rate becomes so poor that a reliable communication link may no longer be established to the base station.

A further advantage is in particular that a change is only made to base stations which remain visible on the further route of the motor vehicle. Unnecessary changes may thus be avoided. This means that, for example, a change is only made to a base station which may be received by the motor vehicle on the setpoint trajectory still to be followed by the motor vehicle.

In particular, an arrangement and a number of the base stations within the parking facility may be efficiently optimized.

The management, i.e., the knowledge, of the positions of the base stations and an initiation of a base station change, may be carried out or assumed, for example, by the parking facility management system or by the motor vehicle itself.

According to one specific embodiment, three areas are defined around a base station. An area is defined as the closest to the base station in which good reception prevails, so that latency and data rate are good. This area corresponds, for example, to first areas 609, 613.

An area subsequently follows, in which the reception becomes poor and therefore the latency becomes greater and the data rate becomes lower. This area corresponds, for example, to areas 611, 615.

Subsequently thereto, i.e., even farther away from the base station, a third area follows, in which the base station is received so poorly that the communication link breaks off. This area is not shown in the figures.

According to one specific embodiment it is provided that the concept according to the present invention is used for an AVP functionality. This means that, for example, in the AVP guiding system, which may be included by the parking facility management system, the digital map is thus provided, as already described above. It is recorded in this digital map for the different areas in the parking facility which base station is received well there and is to be used for the particular area. Since it is also known in the AVP guiding system where the motor vehicle is presently located and where it will move to, the AVP guiding system may instruct the motor vehicle to change to a certain base station as soon as it is about to leave the area having good reception of the present base station. This change may take place very rapidly, as scanning for base stations is not necessary on the part of the motor vehicle. Latency and data rate are thus optimized and a reliable system is achieved for the application.

A further advantage according to the present invention is that as a result of the robust communication link, more efficient operation of the motor vehicle and therefore also in particular of the parking facility may be ensured.

What is claimed is:

1. A method for communicating between a parking facility management system of a parking facility and a motor vehicle driving in a driverless fashion within the parking facility, the parking facility including multiple spatially distributed base stations, the method comprising:
selecting, based on a present position of the motor vehicle within the parking facility and on a digital map of the parking facility which includes the positions of the multiple base stations, a base station from the multiple base stations, to which the motor vehicle is to change next from a present base station of the multiple base stations to which the motor vehicle is presently connected, to connect itself to the selected base station, in order to communicate with the parking facility management system.

2. The method as recited in claim 1, wherein a change instruction that the motor vehicle is to change from the present base station to the selected base station is transmitted via a communication network to the motor vehicle.

3. The method as recited in claim 1, wherein the selection is carried out as a function of a destination position located within the parking facility, to which the motor vehicle is to drive.

4. The method as recited in claim 1, wherein the selection is carried out as a function of a setpoint trajectory to be followed by the motor vehicle.

5. The method as recited in claim 1, wherein the selection is carried out as a function of a present motor vehicle velocity.

6. The method as recited in claim 1, wherein the digital map includes areas around the base stations, which have different reception conditions with respect to at least one of a latency and a data rate, the selection being carried out as a function of the different reception conditions.

7. The method as recited in claim 1, wherein the selection is carried out as a function of one condition that the motor vehicle always has to have a direct line-of-sight to one base station of the multiple base stations.

8. A device for communicating between a parking facility management system of a parking facility and a motor vehicle driving in a driverless fashion within the parking facility, the parking facility including multiple spatially distributed base stations, the device comprising:
a memory in which a digital map of the parking facility is stored, the digital map including the positions of the multiple base stations; and
a processor which is designed to, based on a present position of the motor vehicle within the parking facility and on the digital map of the parking facility, select a base station from the multiple base stations to which the motor vehicle is to change next from a present base station of the multiple base stations, to which the motor vehicle is presently connected, to connect itself to the selected base station, in order to communicate with the parking facility management system.

9. A motor vehicle, including a device for communicating between a parking facility management system of a parking facility and a motor vehicle driving in a driverless fashion within the parking facility, the parking facility including multiple spatially distributed base stations, the device comprising:
a memory in which a digital map of the parking facility is stored, the digital map including the positions of the multiple base stations; and
a processor which is designed to, based on a present position of the motor vehicle within the parking facility and on the digital map of the parking facility, select a base station from the multiple base stations to which the motor vehicle is to change next from a present base station of the multiple base stations, to which the motor vehicle is presently connected, to connect itself to the selected base station, in order to communicate with the parking facility management system.

10. A parking facility management system, including a device for communicating between a parking facility management system of a parking facility and a motor vehicle driving in a driverless fashion within the parking facility, the parking facility including multiple spatially distributed base stations, the device comprising:
a memory in which a digital map of the parking facility is stored, the digital map including the positions of the multiple base stations; and
a processor which is designed to, based on a present position of the motor vehicle within the parking facility and on the digital map of the parking facility, select a base station from the multiple base stations to which the motor vehicle is to change next from a present base station of the multiple base stations, to which the motor vehicle is presently connected, to connect itself to the selected base station, in order to communicate with the parking facility management system.

11. A non-transitory computer readable storage medium on which is stored a computer program for communicating between a parking facility management system of a parking facility and a motor vehicle driving in a driverless fashion within the parking facility, the parking facility including multiple spatially distributed base stations, the computer program, when executed by a computer, causing the computer to perform:
selecting, based on a present position of the motor vehicle within the parking facility and on a digital map of the parking facility which includes the positions of the multiple base stations, a base station from the multiple base stations, to which the motor vehicle is to change next from a present base station of the multiple base stations to which the motor vehicle is presently connected, to connect itself to the selected base station, in order to communicate with the parking facility management system.
